(19) United States
(12) Patent Application Publication
(10) Pub. No.: US 2009/0210442 A1
(43) Pub. Date: Aug. 20, 2009

(54) Collaborative Categorization System

(76) Inventor: Cezary A. Klimczak, Bolton (CA)

Correspondence Address: NEUSTEL LAW OFFICES, LTD., 2534 SOUTH UNIVERSITY DRIVE, SUITE 4, FARGO, ND, 58103, US

(21) Appl. No.: 12/033,913

(22) Filed: Feb. 20, 2008

(51) Int. Cl. G06F 17/30

(52) U.S. Cl. 707/102; 707/E17.001

(57) ABSTRACT

A collaborative categorization system for efficiently allowing communities of users to record and share observations and events. The collaborative categorization system generally includes making an observation, providing a software platform, wherein said software platform is connected to at least one network, recording said observation as an event upon said software platform, categorizing said event within a particular eventset and sharing said event through said eventset upon said at least one network.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to categorizing systems and more specifically it relates to a collaborative categorization system for efficiently allowing communities of users to record and share observations and events.

2. Description of the Related Art

Any discussion of the related art throughout the specification should in no way be considered as an admission that such related art is widely known or forms part of common general knowledge in the field.

People have been recording and sharing observations for years. Generally, the observations are passed to other individuals through word-of-mouth. Problems with passing information through word-of-mouth are that the information may be misheard or misspoken thus leading to inaccurate information pertaining to the observations being passed. Another problem with passing information through word-of-mouth is that it is generally not possible to pass the information to a large number of individuals thus limiting the number of individuals who can take advantage of the observation.

Other ways in which individuals pass on information are through the use of newspapers, magazines or books. These may reach more people than word of mouth; however, the information passed this way generally takes a few days or longer to reach individuals, the length of time depending on the medium through which the information is sent (e.g., books generally take longer than magazines or newspapers).

Another problem with passing information relating to observations or events through a newspaper, magazine or book is that other individuals who are not a part of the direct editing of the publication (i.e. newspaper, magazine, book) may not be able to comment on the observation for others to see, thus limiting the feedback or thoughts pertaining to the particular observation.

Because of the inherent problems with the related art, there is a need for a new and improved collaborative categorization system for efficiently allowing communities of users to record and share observations and events.

### BRIEF SUMMARY OF THE INVENTION

The general purpose of the present invention is to provide a collaborative categorization system that has many of the advantages of the categorizing systems mentioned heretofore. The invention generally relates to a categorizing system which includes making an observation, providing a software platform, wherein said software platform is connected to at least one network, recording said observation as an event upon said software platform, categorizing said event within a particular eventset and sharing said event through said eventset upon said at least one network.

There have thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a collaborative categorization system for efficiently allowing communities of users to record and share observations and events.

Another object is to provide a collaborative categorization system that does not focus on a specific type of event.

An additional object is to provide a collaborative categorization system that is application-independent, wherein a wide variety of applications that record and/or use the events in a collaborative manner can be supported.

A further object is to provide a collaborative categorization system that is mapping independent, wherein the eventset is an abstract entity.

Another object is to provide a collaborative categorization system that is user interface independent.

Another object is to provide a collaborative categorization system that allows multiple users to record observations about particular events.

Another object is to provide a collaborative categorization system that allows for the collaborative viewing and classification of events within eventsets.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flowchart illustrating a process of utilizing the present invention.

FIG. 2 is a Venn diagram illustrating the relationship between the software platform, the eventsets and the events.

FIG. 3 is a diagram illustrating the information stored by a user pertaining to a particular event.

FIG. 4 is a diagram illustrating the information stored by a user pertaining to a particular eventset.

FIG. 5 is a diagram illustrating the various features present in the system services (i.e. front end) of the software platform.

### DETAILED DESCRIPTION OF THE INVENTION

### A. Overview

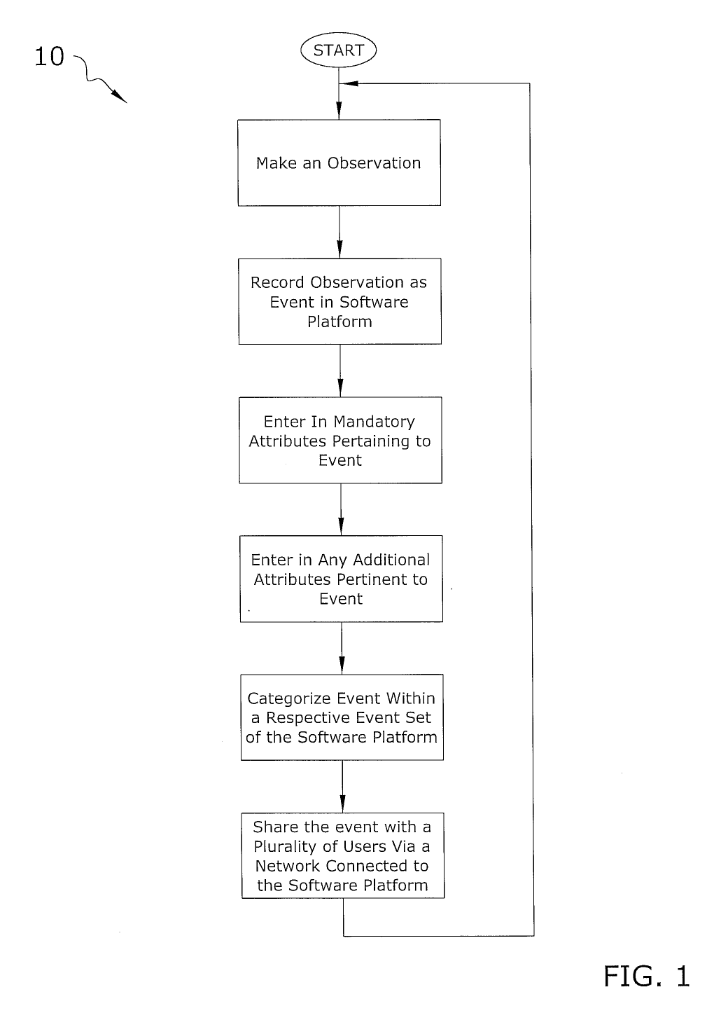

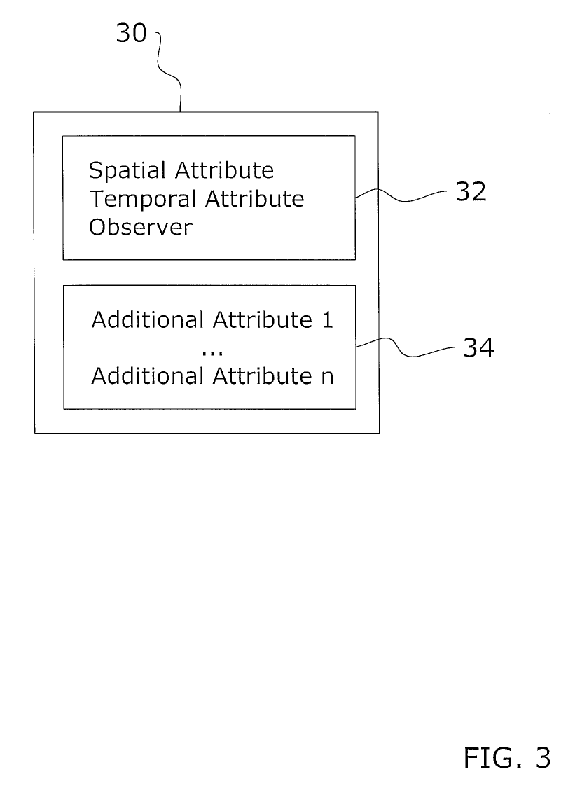

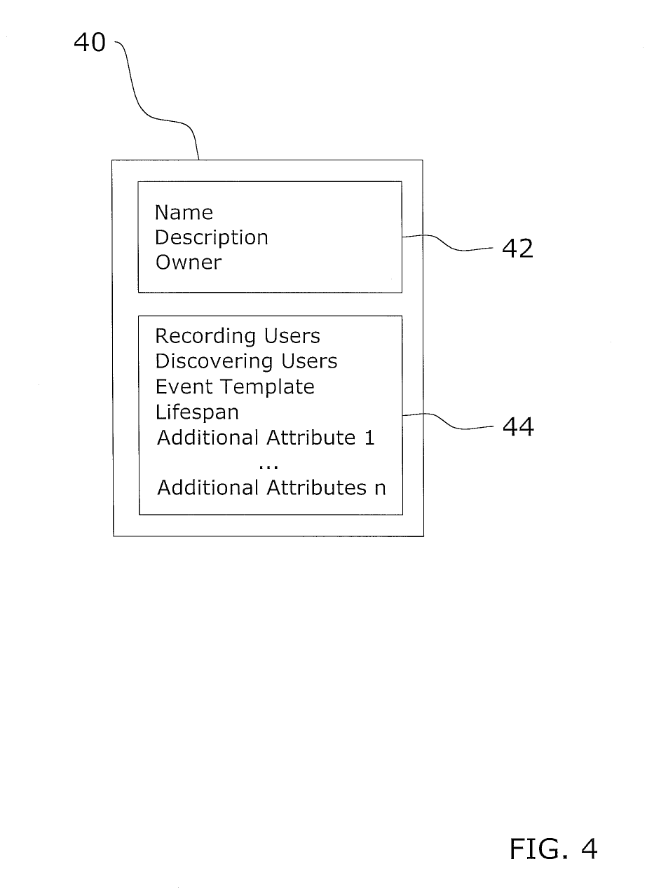

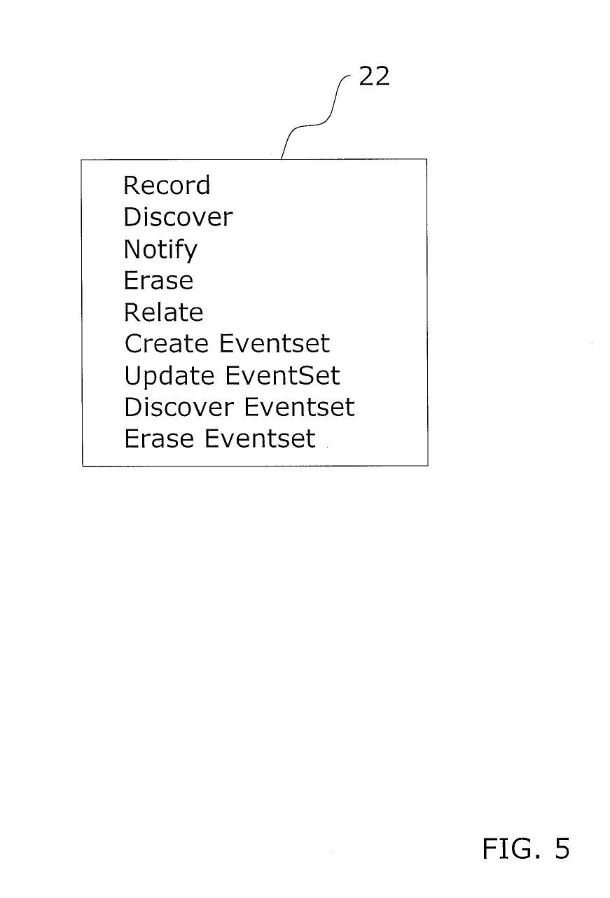

Turning now descriptively to the drawings, in which similar reference characters denote similar elements throughout the several views, FIGS. 1 through 5 illustrate a collaborative categorization system 10, which comprises making an observation, providing a software platform 20, wherein said software platform 20 is connected to at least one network, recording said observation as an event 30 upon said software platform 20, categorizing said event 30 within a particular eventset 40 and sharing said event 30 through said eventset 40 upon said at least one network.

### B. Software Platform

The software platform 20 serves as the infrastructure to contain all of the events 30 and eventsets 40. The platform 20 may be comprised of a web address and communicated to the users of the present invention through the Internet, or the platform 20 may be communicated through a local network among a smaller group of individuals if desired. The platform 20 preferably has the capability to become a global platform 20 for the collaborative recording of observations and to accumulate numerous events 30, event 30 types and eventsets 40 so that the events 30, event 30 types and eventsets 40 can be studied for causal and other types of relationships.

The platform 20 and present invention may be accessed from various types of electronic devices connected to the respective network of which the platform 20 is a part. Such electronic devices include a smart phone, a personal computer, a vehicle computer and various others. The platform 20 is preferably reachable through an http address; however it is appreciated that the platform 20 may be physically distributed.

The platform 20 includes various searching and categorizing functions to organize the events 30 and eventsets 40 including various services and features for the management of events 30 and eventsets 40, all preferably contained within a system services 22 section of the “front end” (i.e. portion of software platform 20 that users view and directly utilize) of the software platform 20.

A record feature allows users to create and record a single event 30 into one or more eventset 40. It is appreciated that when recording an event 30 the user ensures that all the required attributes have been provided.

A discover feature allows the user to browse an eventset 40 and retrieve a subset of events 30 that match the specified criteria (e.g. retrieve all temperature events 30 recorded in the last 2 hours in the 25 mile radius west of my current position, etc.). It is appreciated that the discover feature may search based on one or several attributes.

A notify feature allows a user to request instantaneous notification whenever an event 30 that matches specified search criteria is recorded or deleted from an eventset 40.

An erase feature allows a user to remove a previously recorded event 30 from the platform 20. In the preferred embodiment, the event 30 can only be removed by the user who recorded the event 30 or the owner of an eventset 40 to which a respective event 30 belongs.

A relate feature allows a user to establish a relationship between a set of events 30 and describe the type of this relationship (e.g., causal, correlational or other). It is appreciated that the relate feature may relate events 30 within a particular eventset 40 or within multiple eventsets 40.

The platform 20 also preferably includes various features to manage eventsets 40. Such features include, but are not limited to, “create eventset”, “update eventset”, “discover eventset”, “erase eventset” and various others.

A create eventset feature allows a user to create a new eventset 40 and define the eventset's 40 properties. The user who invokes the create eventset 40 feature becomes the owner of the newly created eventset 40.

An update eventset feature allows the owner of the eventset 40 to update the properties of the eventset 40.

A discover eventset feature allows users to browse the platform 20 for eventsets 40 that match specified search criteria involving one or more eventset 40 properties.

An erase eventset feature allows the owner of an eventset 40 to delete the eventset 40 from the platform 20 including all the events 30 recorded within the eventset 40.

The events 30 and eventsets 40 of the platform 20 are managed by the platform's 20 back end, whereas the front end implements the services and features 22 through which the events 30 and eventsets 40 of the back end can be discovered and manipulated.

It is appreciated that each eventset 40 may include various other features, such as “Recording Users”, “Discovering Users”, “Event Template”. The recording, discovering and template features are preferably utilized when adding new users and creating new events or eventsets upon the software platform.

### C. Events

An event 30 encapsulates information associated with a phenomenon observed by a user of the system. An event 30 carries information about where the observed phenomenon happened (spatial coordinates), when it happened (temporal coordinates), and who observed it (via the user's signature, login name), all recorded as attributes of said event 30. The spatial, temporal, and observer attributes are generally mandatory attributes 32. It is appreciated that each of the events 30 may also carry additional information about the phenomenon recorded in additional attributes 34. Each event has a unique identity, i.e., any two events are different from each other.

Additional attributes 34 generally describe any other attributes of an event 30 that go beyond the attributes “where” (i.e. spatial) and “when” (i.e. temporal) that are common to all events. It is appreciated that certain applications of the present invention may require events 30 to carry additional attributes 34, wherein the additional attributes 34 may be known only to the user community that understands the specific application of the present invention (e.g., a community of amateur meteorologists might agree that all Temperature events submitted by the community members need to have an optional attribute 34 “Temperature Reading” provided in addition to the spatial and temporal attributes common to all events 30).

The user community, as described in the present invention, is a group of collaborating users that are interested in events 30 of a specific type. It is appreciated that a given user may be a member of a plurality of communities. An event 30 submitted upon the platform 20 and within a given eventset 40 by a member of a community (i.e. user) becomes visible to all other members of the respective community.

### D. Eventsets

Each event 30 is recorded by the system in an eventset 40 specified by the originating user, wherein the eventset 40 is generally a collection of related events 30. The events 30 and eventsets 40 are preferably located within the system logic 24 portion or “back end” of the software platform (i.e. the portion of the software platform 20 not viewable to the users and utilized to retain and direct information). The eventset 40 is generally defined by the creator of the eventset 40, who becomes its owner.

The purpose of each eventset 40 is known to the community of users that use the eventset 40 (e.g. an eventset 40 for recording owl sightings). The platform 20 is not generally aware of the purpose of the eventset 40, and does not automatically assign an event 30 to a particular eventset 40. Indirectly, eventsets 40 define various user communities as they partition all system users into subgroups that share interest in a specific type of event 30 (e.g. the community of users interested in keeping track of owl sightings).

Each eventset 40 generally has a name property and a description property. The eventset 40 name and description help users of the present invention to recognize each eventset 40 among the other eventsets 40 in the system. The ease of locating each eventset 40, and thus an adequate characterization of each eventset 40, becomes increasingly important as the number of eventsets 40 increases.

It is appreciated that each eventset 40 will have name and description properties to adequately characterize the eventset 40 for users. Each eventset 40 will also have an owner property specifying the owner of the eventset 40. The name, description, and owner properties of each eventset are generally mandatory attributes 42. It is appreciated that the owner of each eventset 40 may mandate that all events to be submitted to the respective eventset 40 include specific additional attributes 44 in addition to the mandatory attributes 42.

### E. Applications for the Platform

Various types of applications may be added to the platform 20 of the present invention to accomplish various types of tasks. One such task involves registering and sharing events 30. An example is an application that allows home owners to record a “sell by owner” event 30, wherein the application also notifies all interested users when a “sell by owner” event 30 happens in their area of interest. Another example of registering and sharing events 30 includes an application that advertises the three cheapest gas stations relative to the user's current location. A further application of registering and sharing events 30 includes a portable gadget that allows users to record observations of car accidents and their severities (e.g. minor, serious, multi-vehicle, etc.) and notifies the user (e.g. through beeps, etc.) when the user is approaching a car accident recently spotted by others.

Another task for which applications may be desired is to overlay a mesh or multiple meshes on a spatial or temporal mapping system (e.g. geographical, astronomical, etc.). An example of such an application is a program that overlays locations of owl sightings from the last two weeks on a map of France or a program that overlays locations of “open door parties” scheduled to happen in a high-rise apartment building next month, wherein the events 30 are overlayed on the plan of the building.

Another task for which applications may be desired is real-time processing of events 30. An example of such an application is a program that analyzes multiple car accident events 30 recorded within 200 meters of each other and submitted within the last 2 hours by multiple independent users, wherein the program aggregates these events 30 into a new single event 30 that is recorded in the system. Another example of an application that performs real-time processing of events 30 is a program or gadget that displays in real time the number of owl sightings in the last 24 hours that happened within a 10 kilometer range of the user's current location.

A further task for which applications may be desired is the performance of data mining, research and other types of analysis in order to understand relationships between events 30. An example of such an application is an artificial intelligence program that looks for correlations between the increased temperatures and humidity in the last month and the decreased number of owl sightings in France.

Another example of an application that performs data mining, research and other types of analysis in order to understand relationships between events 30 is a program that predicts the “safety” of an incoming intersection or a stretch of highway (e.g. based on the time of day, car accident event 30 data in last 5 years, etc.) and presents the information to the driver by displaying a color coded advisory (e.g. green for low risk, red for high risk, etc.). A further example of an application that understands relationships is a human-performed analysis that concludes that two seemingly unrelated categories of events 30 (e.g. honey bee sightings and pesticide applications, etc.), which have been tracked on the platform 20 for the last 10 years by two independent groups, are actually in a cause-effect relationship (e.g. the presence of the pesticide drives away the bees, etc.).

### F. Operation of Preferred Embodiment

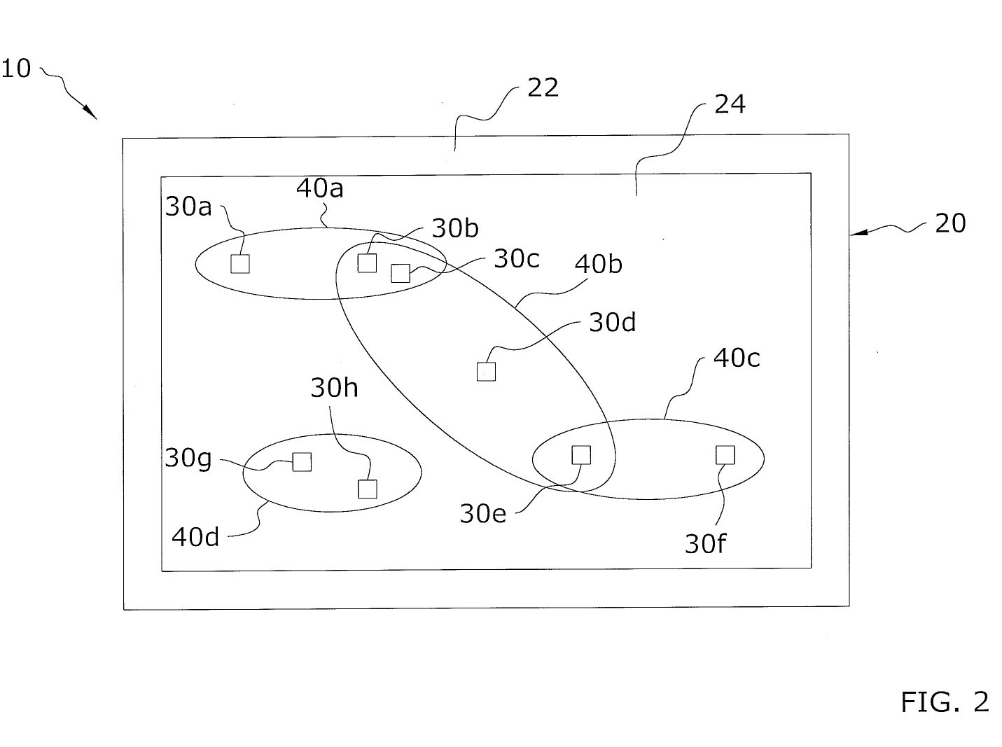

In use, the present invention is utilized to allow individuals to take note of observations of the real world (i.e. things the individuals have seen, felt, heard, smelt, etc.) around them and record them as events 30 upon the platform 20. The events may also be categorized in more than one eventset as illustrated in FIG. 2 (e.g. events 30a, 30b, 30c are in eventset 40a; events 30b, 30c, 30d, 30e are in eventset 40b; events 30e, 30f are in eventset 40c; events 30g, 30h are in eventset 40d). The events 30 may also be compared to other events 30 to reveal similarities, patterns or relationships between the events 30.

Examples of observations that the user may share and record as events 30 are: “it's raining here”—recorded by an amateur meteorologist, “I have just seen an owl”—recorded by an ornithology hobbyist, “I'm coming down with the flu”—recorded by an infectious disease tracker, “I have just spotted a car accident”—recorded by a driver who takes note of dangerous highway spots, “The price of gas here has just changed. It is $2.80 per gallon now.”—recorded by a savvy consumer. Various other observations may be recorded as events 30. The users can thus collaboratively capture and share information pertaining to the particular type of event 30 of interest.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A method for a collaborative categorization system, comprising:
making an observation;
providing a software platform, wherein said software platform is connected to at least one network;
recording said observation as an event upon said software platform;
categorizing said event within a particular eventset; and
sharing said event through said eventset upon said at least one network.

2. The method for a collaborative categorization system of claim 1, wherein said eventset includes a plurality of said events.

3. The method for a collaborative categorization system of claim 2, including a step of establishing a relationship between said plurality of events.

4. The method for a collaborative categorization system of claim 2, including a step of establishing a relationship between said plurality of events of a plurality of different said eventsets.

5. The method for a collaborative categorization system of claim 1, wherein said eventset includes a plurality of said events each with at least one common factor.

6. The method for a collaborative categorization system of claim 1, wherein said event includes a spatial attribute and a temporal attribute.

7. The method for a collaborative categorization system of claim 1, wherein said software platform includes an application to register and share events of a specific type.

8. The method for a collaborative categorization system of claim 1, wherein said software platform includes a mapping system.

9. The method for a collaborative categorization system of claim 8, wherein said event is overlayed upon said mapping system.

10. The method for a collaborative categorization system of claim 1, wherein said software platform includes an application for real-time processing of said events.

11. The method for a collaborative categorization system of claim 1, wherein said software program includes an application to find relationships between a plurality of said events.

12. The method for a collaborative categorization system of claim 1, wherein each said eventset and included said events within said eventset are within a particular spatial and temporal domain.

13. A method for a collaborative categorization system, comprising:
making a plurality of observations;
providing a software platform, wherein said software platform is connected to at least one network;
recording said plurality of observations as a plurality of events upon said software platform, wherein each of said plurality of events includes a spatial attribute and a temporal attribute;
categorizing said plurality of events within at least one eventset, wherein said at least one eventset including said plurality of events establishes said at least one common factor between said plurality of events; and
sharing said plurality of events through said at least one eventset upon said at least one network.

14. The method for a collaborative categorization system of claim 13, including a step of establishing a relationship between said plurality of events.

15. The method for a collaborative categorization system of claim 13, wherein each said eventset and included said events within said eventset are within a particular spatial and temporal domain.

16. The method for a collaborative categorization system of claim 13, wherein said software platform includes a mapping system, wherein said plurality of events are overlayed upon said mapping system.

17. A collaborative categorization system, comprising:
a software platform;
a plurality of events stored upon said software platform, wherein said plurality of events represent a plurality of observations made;
wherein each of said plurality of events includes a plurality of attributes;
wherein said plurality of attributes include at least one temporal attribute and at least one spatial attribute relating to said plurality of observations made; and
at least one eventset stored upon said software platform, wherein said at least one eventset classifies said plurality of events within at least one particular category according to at least one common factor between said plurality of events.

18. The collaborative categorization system of claim 17, including at least one computer network, wherein said software platform is communicatively connected to said at least one computer network.

19. The collaborative categorization system of claim 17, wherein at least one of said plurality of events is simultaneously within a plurality of said eventsets.

20. The collaborative categorization system of claim 17, wherein said software platform includes a mapping system to display said plurality of events with respect to said at least one spatial or temporal attribute of said plurality of events.
